(19) United States
(12) Patent Application Publication
(10) Pub. No.: US 2016/0144392 A1
(43) Pub. Date: May 26, 2016

(54) APPARATUS FOR ORGANIC LAYER DEPOSITION

(71) Applicant: Samsung Electronics Co., Ltd., Suwon-si (KR)

(72) Inventors: Seung-Min RYU, Suwon-si (KR); Bo-Kyung JUNG, Seoul (KR); Kwang-Hyuk CHOI, Suwon-si (KR); Nam-Hoon LEE, Ansan-si (KR); Jong-Hyun LEE, Hwaseong-si (KR); Jin SHIN, Suwon-si (KR); Kyeong-Min YEO, Hwaseong-si (KR); Jong-Han OH, Suwon-si (KR)

(21) Appl. No.: 14/809,548

(22) Filed: Jul. 27, 2015

(30) Foreign Application Priority Data
Nov. 25, 2014 (KR) 10-2014-0165342

(51) Int. Cl. B05B 15/04; B05B 12/00

(52) U.S. Cl. CPC B05B 15/04; B05B 12/004

(57) ABSTRACT

An apparatus for organic layer deposition is provided that can improve precision of a gap between a substrate and a mask by correcting a position of a mask stage having a mask mounted thereon based on a substrate shape, and that can reduce a measurement error of a mask surface by pre-measuring a position of a mask and determining an initial position of the mask based on the measured position. The apparatus includes a shape measuring sensor, a substrate carrier, a deposition material discharge source, a mask including a plurality of pattern slits, a camera measuring an alignment error between the substrate and the mask, a distance measuring sensor measuring an alignment error between the substrate and the mask, and a mask stage controlling a position of the mask.

### CROSS-REFERENCE TO RELATED APPLICATION

This application claims priority from Korean Patent Application No. 10-2014-0165342 filed on Nov. 25, 2014 in the Korean Intellectual Property Office, and all the benefits accruing therefrom under 35 U.S.C. 119, the contents of which are herein incorporated by reference in their entirety.

### BACKGROUND

1. Field of the Invention

Example embodiments relate to an apparatus for organic layer deposition.

2. Description of the Related Art

An organic light-emitting diode is typically a self-emissive display device based on an electroluminescence phenomenon where light is emitted when current flows through an organic compound. The organic light-emitting diode has been spotlighted as a next-generation display because of a wide viewing angle, a quick response, a low driving voltage, a superior contrast ratio, and other such advantages. The organic light-emitting diode implements a color display using light emission occurring when electrons and holes injected from a cathode and an anode are recombined in an organic emission layer. In general, the organic emission layer is composed of a hole injection layer, a hole transport layer, an light emission layer, an electron transport layer and an electron injection layer, and an organic pattern is formed thereon by a vacuum thermal deposition method using a fine metal mask (FMM). The FMM, in which a substrate and a metal mask have substantially the same size, is generally used for manufacturing a medium-small sized organic light-emitting display. However, the deposition method using an FMM is generally not suitable for manufacturing larger devices using a mother glass having a size of 5G (1100×1300 mm) or greater. In other words, when such a large metal mask is used, the metal mask may bend.

### SUMMARY

Example embodiments relate to an apparatus for organic layer deposition, which can improve precision of a gap between a substrate and a mask by correcting a position of a mask stage having a mask mounted thereon based on a substrate shape, and which can reduce a measurement error of a mask surface by pre-measuring a position of a mask and determining an initial position of the mask based on the measured position.

The above and other example embodiments will be described in or be apparent from the following description s.

According to example embodiments, there is provided an apparatus for organic layer deposition, the apparatus including a shape measuring sensor configured to measure shapes of the substrate, a carrier conveying the substrate in a first direction, a deposition source discharging a deposition material to the substrate, a mask disposed between the substrate and the deposition source and including a plurality of pattern slits arranged in a second direction crossing the first direction, a camera measuring an alignment error between the substrate and the mask and measuring straightness of the carrier in the second direction, a distance measuring sensor measuring an alignment error between the substrate and the mask and measuring flatness of the carrier in the third direction crossing the first and second directions, and a mask stage controlling a position of the mask based on the measured shapes of the substrate and the measured alignment error between the substrate and the mask, wherein the organic layer deposition using the deposition source is performed when the substrate is conveyed by the carrier in the first direction and passes through a region between the mask and the distance measuring sensor.

The shape measuring sensor includes a first sub shape measuring sensor including a first sensor and a second sensor arranged in the second direction.

The first and second sensors are arranged along outer lines spaced apart from each other in the second direction of the substrate and facing each other.

The first sub shape measuring sensor further includes a jig fixing the first and second sensors in the third direction.

The apparatus further comprises a driving unit moving the shape measuring sensor in the first direction; and a guide unit guiding the driving unit in the first direction.

The carrier includes an electrostatic chuck for attaching the substrate.

The mask stage has 5-axes degrees of freedom, and the 5-axes degrees of freedom include degrees of freedom with respect to the second direction and third direction and degrees of freedom with respect to directions rotating about axes of the first to third directions.

The camera measures an error with respect to the second direction and an error with respect to a direction rotating about the axis of the second direction among alignment errors between the substrate and the mask.

The camera measures alignment errors between the substrate and the mask by simultaneously or contemporaneously measuring an alignment mark of the substrate and an alignment mark of the mask.

The distance measuring sensor measures an error with respect to the third direction and an error with respect to a direction rotating about the axis of each of the first and third directions among alignment errors between the substrate and the mask.

Each of the shape measuring sensor and the distance measuring sensor includes one of, for example, a confocal sensor, a laser triangulation sensor, a spectral-interference laser displacement sensor, an eddy current sensor, and a capacitive sensor.

The camera includes a plurality of cameras, and the plurality of cameras are positioned on edges of the mask.

The distance measuring sensor includes first to fourth sub-distance measuring sensors, and the first to fourth sub-distance measuring sensors are positioned on edges of the mask.

The first and second sub-distance measuring sensors are disposed to face each other in the first direction, the third and fourth sub-distance measuring sensors are disposed to face each other in the first direction, and the first and second sub-distance measuring sensors are disposed to face the third and fourth sub-distance measuring sensors in the second direction.

The distance measuring sensor further includes a fifth sub-distance measuring sensor spaced apart from the first sub-distance measuring sensor in the first direction while not overlapping with the mask, and a sixth sub-distance measuring sensor spaced apart from the third sub-distance measuring sensor in the first direction while not overlapping with the mask, wherein the substrate firstly passes through the fifth sub-distance measuring sensor and lastly passes through the sixth sub-distance measuring sensor when the substrate passes through a region between the distance measuring sensor and the mask.

When the mask passes through bottom ends of the first and fifth sub-distance measuring sensors, the mask stage controls a position of the mask based on the position and shape data of the substrate, when the mask passes through bottom ends of the first and second sub-distance measuring sensors, the mask stage controls a position of the mask based on the position data of the substrate and, when the mask passes through bottom ends of the second and sixth sub-distance measuring sensors, the mask stage controls a position of the mask based on the position and shape data of the substrate.

The distance measuring sensor measures alignment errors between the substrate and the mask based on the position of the mask measured before the substrate and the mask overlap with each other and the position of the mask measured after the substrate and the mask overlap with each other.

The apparatus further comprises a controller controlling the mask stage, wherein the controller controls the mask stage based on the shapes of the substrate, measured by the shape measuring sensor, and the alignment errors between the substrate and the mask, measured by the camera and the distance measuring sensor.

According to example embodiments, an apparatus for organic layer deposition for forming an organic layer on a substrate includes a shape measuring sensor disposed at a bottom end of the substrate and configured to measure shapes of the substrate, a carrier conveying the substrate in a first direction, a deposition source discharging a deposition material to the substrate, a mask disposed between the substrate and the deposition source and including a plurality of pattern slits arranged in a second direction crossing the first direction, a distance measuring sensor measuring alignment errors between the substrate and the mask, and a mask stage controlling a position of the mask based on the measured shapes of the substrate and the measured alignment errors between the substrate and the mask, wherein the shape measuring sensor includes first and second sensors arranged in the second direction, and the first and second sensors are spaced apart from each other in the second direction of the substrate and arranged along outer lines facing each other.

According to example embodiments, an apparatus for organic layer deposition for forming an organic layer on a substrate includes a shape measuring sensor measuring shapes of the substrate, a deposition source discharging a deposition material to the substrate, a mask disposed between the substrate and the deposition source and including a plurality of pattern slits arranged in a second direction crossing the first direction, a distance measuring sensor measuring alignment errors between the substrate and the mask, and a mask stage controlling a position of the mask based on the measured shapes of the substrate and the measured alignment errors between the substrate and the mask, wherein the distance measuring sensor includes first to sixth sub-distance measuring sensors and the first to fourth sub-distance measuring sensors are positioned on edges of the mask, the fifth sub-distance measuring sensor is positioned at one side of the mask so as not to overlap with the mask and the sixth sub-distance measuring sensor is positioned at the other side of the mask so as not to overlap with the mask, the substrate firstly passes through the fifth sub-distance measuring sensor and lastly passes through the sixth sub-distance measuring sensor when the substrate passes through a region between the distance measuring sensor and the mask, when the mask passes through bottom ends of the first and fifth sub-distance measuring sensors, the mask stage controls a position of the mask based on the position and shape data of the substrate, when the mask passes through bottom ends of the first and second sub-distance measuring sensors, the mask stage controls a position of the mask based on the position data of the substrate, and when the mask passes through bottom ends of the second and sixth sub-distance measuring sensors, the mask stage controls a position of the mask based on the position and shape data of the substrate.

Example embodiments also include an apparatus for organic layer deposition on a substrate, the apparatus including a substrate on a carrier, a deposition material source on a path of the carrier in a first direction, a mask between the substrate and the deposition material source, a first sensor configured to measure an alignment error between the mask and the substrate and to output a first signal corresponding to the measured alignment error, a second sensor configured to measure a shape of the substrate and to output a second signal corresponding to the measured shape of the substrate, and a mask controller configured to control a position of the mask based on at least one of the first signal and the second signal.

### BRIEF DESCRIPTION OF THE DRAWINGS

The above and other features and advantages of example embodiments will become more apparent with reference to the attached drawings in which:

FIG. 1 is a schematic diagram of an organic layer deposition apparatus according to an example embodiment;

FIGS. 2 and 3 are diagrams illustrating a connection relationship between an example substrate and an example carrier shown in FIG. 1;

FIG. 4 is a perspective view of an example mask shown in FIG. 1;

FIG. 5 is a perspective view of an example mask stage shown in FIG. 1;

FIG. 6 is a perspective view of a deposition source shown in FIG. 1;

FIG. 7 is a schematic diagram of a camera and an example distance measuring sensor shown in FIG. 1;

FIG. 8 is a schematic diagram of a portion of a controller connected to an example distance measuring sensor shown in FIG. 7;

FIGS. 9 and 10 are diagrams illustrating an example method of arranging a distance measuring sensor shown in FIG. 7;

FIGS. 11 and 12 are diagrams illustrating a case in which a substrate shown in FIG. 1 is not planar;

FIGS. 13 to 21 are diagrams of an example shape measuring sensor shown in FIG. 1;

FIG. 22 is a schematic diagram of a controller controlling the example mask stage shown in FIG. 1;

FIG. 23 is a flowchart illustrating an example operating method of the organic layer deposition apparatus shown in FIG. 1;

FIGS. 24 to 28 are diagrams illustrating an example of applying the organic layer deposition apparatus operating method shown in FIG. 23 to a planar substrate; and

FIGS. 29 to 33 are diagrams illustrating an example of applying the organic layer deposition apparatus operating method shown in FIG. 23 to a non-planar substrate.

### DETAILED DESCRIPTION OF THE EMBODIMENTS

Advantages and features of the example embodiments and methods of accomplishing the same may be understood more readily by reference to the following detailed description and the accompanying drawings. The inventive concepts may, however, be embodied in many different forms and should not be construed as being limited to the example embodiments set forth herein. Rather, these example embodiments are provided so that this disclosure will be thorough and complete and will fully convey the concept of the inventive concepts to those skilled in the art, and the inventive concepts will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items. Further, it will be understood that when a layer is referred to as being “under” another layer, it can be directly under or one or more intervening layers may also be present. In addition, it will also be understood that when a layer is referred to as being “between” two layers, it can be the only layer between the two layers, or one or more intervening layers may also be present.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

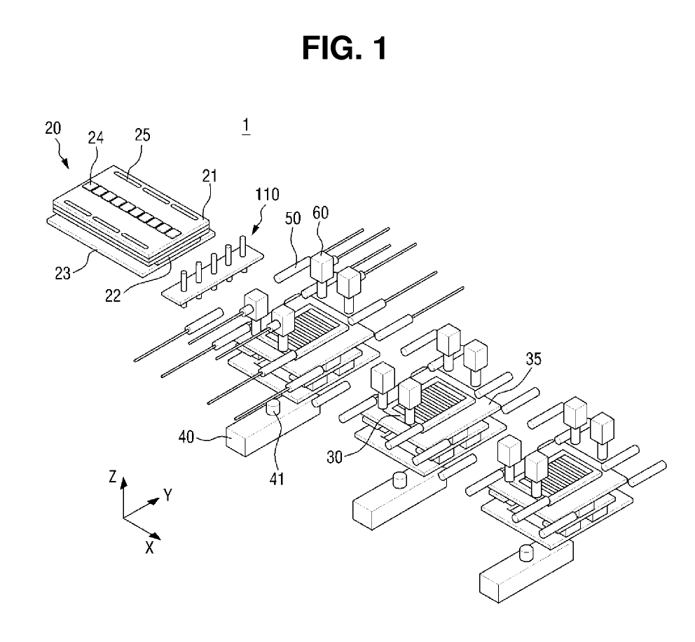

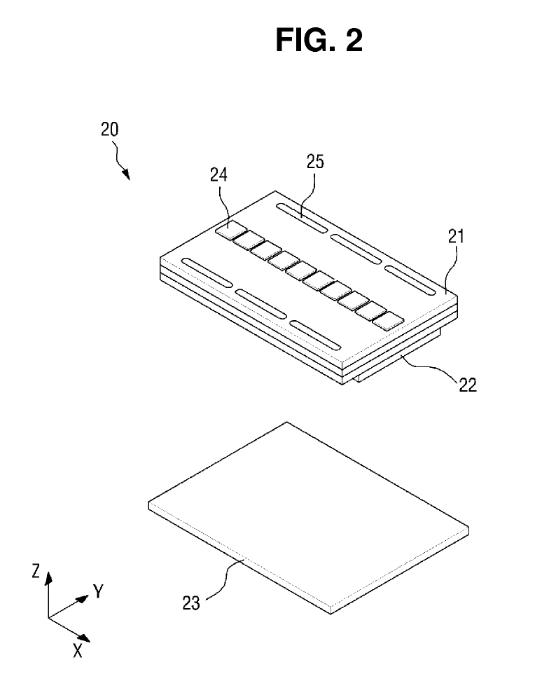

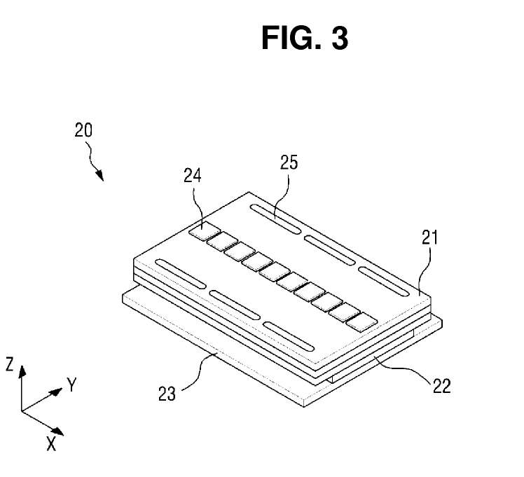

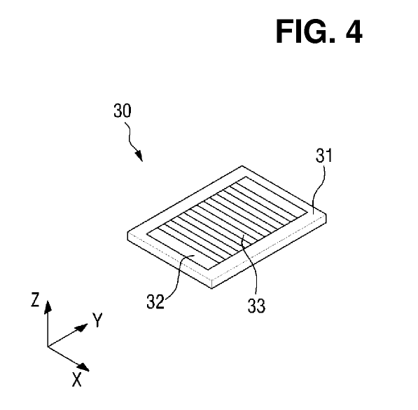

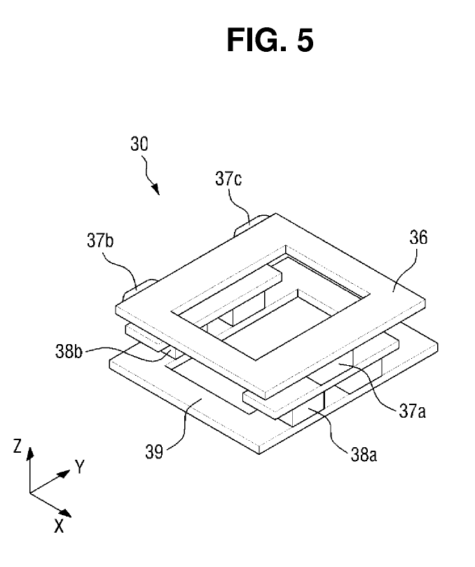

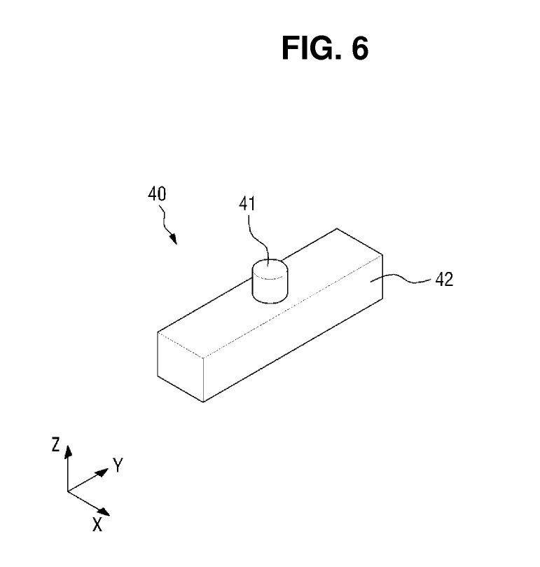

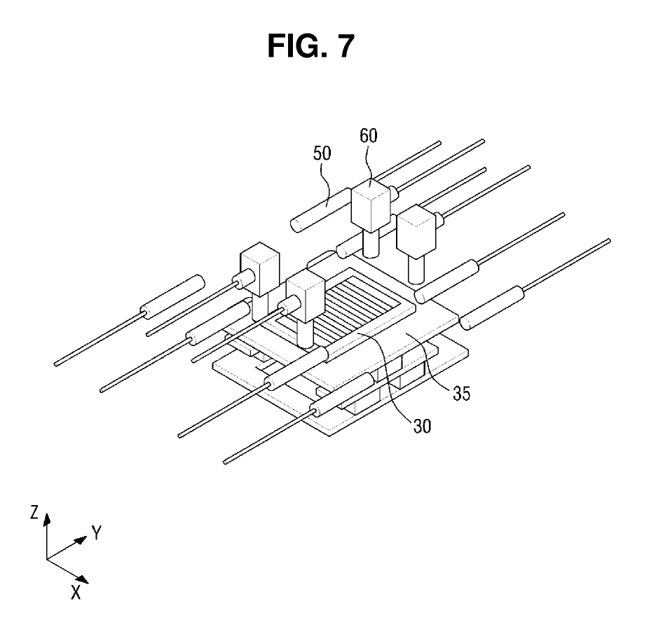

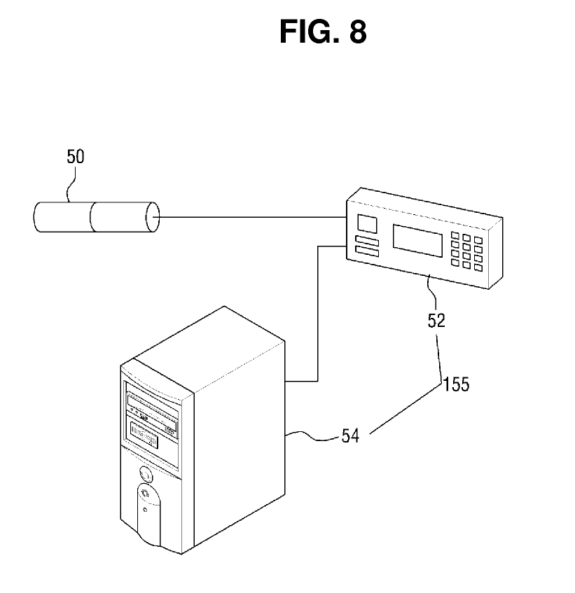

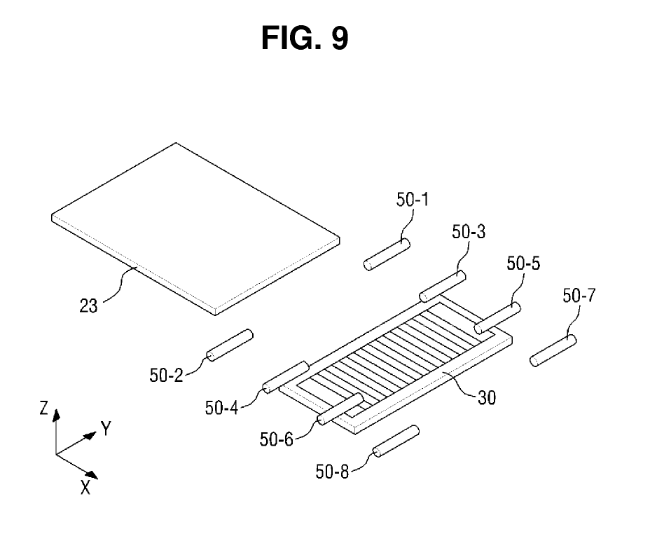

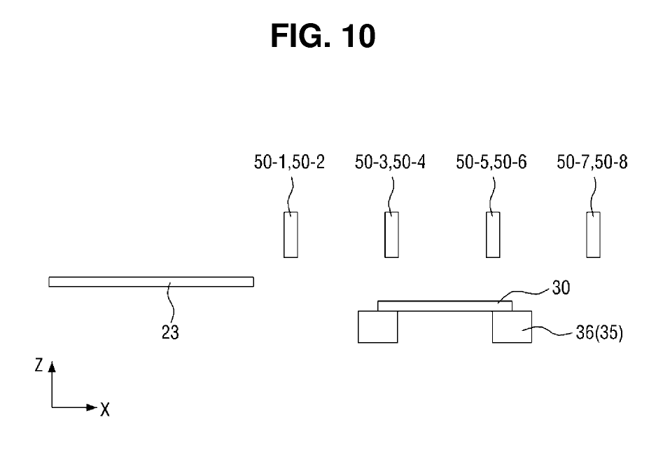

Hereinafter, an apparatus for organic layer deposition according to an example embodiment will be described with reference to FIGS. 1 to 10. FIG. 1 is a schematic diagram of an organic layer deposition apparatus according to an example embodiment, FIGS. 2 and 3 are diagrams illustrating a connection relationship between a substrate and a carrier shown in FIG. 1, FIG. 4 is a perspective view of a mask shown in FIG. 1, FIG. 5 is a perspective view of a mask stage shown in FIG. 1, FIG. 6 is a perspective view of a deposition source shown in FIG. 1, FIG. 7 is a schematic diagram of a camera and a distance measuring sensor shown in FIG. 1, FIG. 8 is a schematic diagram of a portion of a controller connected to a distance measuring sensor shown in FIG. 7, and FIGS. 9 and 10 are diagrams illustrating an example method of arranging a distance measuring sensor shown in FIG. 7.

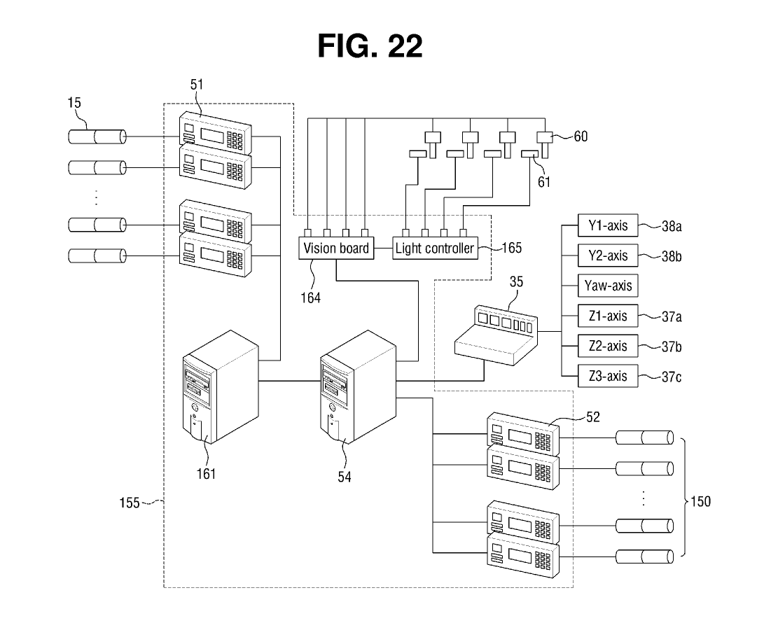

Referring to FIG. 1, the organic layer deposition apparatus 1 according to an example embodiment may include a carrier 20, a mask 30, a mask stage 35, a deposition source 40, a distance measuring sensor 50, a camera 60, a shape measuring sensor 110, and a controller (not shown). The controller (not shown) will later be described in detail with reference to FIG. 22. Here, the substrate 23 may be, for example, a glass substrate, but example embodiments are not limited thereto.

In the organic layer deposition apparatus 1 according to an example embodiment, an organic material may be gradually deposited on the substrate 23 by moving the substrate 23 relative to the fixed deposition source 40 using the carrier 20. A deposition material discharged from the deposition source 40 may thus be deposited on the substrate 23 through pattern slits of the mask 30. The mask stage 35 may control a position of the mask 30 to correct an alignment error between the substrate 23 and the mask 30. Here, the mask stage 35 may control the position of the mask 30 based on the shape of the substrate 23, measured by the shape measuring sensor 110, and alignment errors between the substrate 23 and the mask 30 may be measured by the distance measuring sensor 50 and the camera 60. Various functional components of the organic layer deposition apparatus 1 will later be described in more detail.

In example embodiments, referring to FIG. 2, the carrier 20 may include a carrier body part 21, an electrostatic chuck 22 for attaching the substrate 23, a linear motion driving unit 24 conveying the carrier 20, and a guide unit 25 determining a transfer direction of the carrier 20. FIG. 2 illustrates the example embodiment where the carrier 20 and the substrate 23 are separated from each other.

The electrostatic chuck 22 is configured to attach the substrate 23 through an on/off switch. In addition, the carrier 20 may move through a linear motion in a first direction X by the linear motion driving unit 24. Here, the linear motion driving unit 24 includes a permanent magnet and may be positioned on a top surface of the carrier 20 to move the carrier 20 in the first direction X for returnable transport movement of the carrier 20 in a vacuum chamber (not shown). However, the carrier 20 moved in a moving magnet type is illustrated in FIG. 2, but example embodiments are not limited thereto.

The guide unit 25 of the carrier 20 may include a linear motion (LM) rail or a magnetic floating bearing and may determine the transfer direction of the carrier 20.

Referring to FIGS. 1 and 3, the substrate 23 is attached to the carrier 20, unlike in FIG. 2. A process of conveying the substrate 23 of the carrier 20 will now be briefly described. The carrier 20 having the substrate 23 attached thereto in a loading chamber (not shown) circulates by allowing an organic material to be deposited on the substrate 23 while passing through the deposition source 40 and unloading the substrate 23 from an unloading chamber (not shown).

A process of attaching the substrate 23 to the carrier 20 and conveying the substrate 23 will now be described. First, the substrate 23 is placed on the electrostatic chuck 22 in the loading chamber (not shown) such that a top surface of the substrate 23 faces upward. The substrate 23 placed on the electrostatic chuck 22 is aligned and the electrostatic chuck 22 is switched ‘on’ to attach the substrate 23 to the electrostatic chuck 22. The carrier 20 having the substrate 23 attached thereto may be inverted or flipped upside down to then move in the first direction X along a transport line (not shown) and the organic material discharged from the deposition source 40 is sequentially deposited on the substrate 23. Here, after the carrier 20 is inverted upside down, the substrate 23 is positioned to face the mask 30 and the deposition source 40 when it passes through the deposition source 40. If the carrier 20 passes through a plurality of deposition sources 40 arranged in the first direction X and the deposition of the organic material on the substrate 23 is completed, the carrier 20 may be again inverted or flipped upside down and the electrostatic chuck 22 is switched ‘off’ to unload the substrate 23. The carrier 20 forms a returnable transport process while moving to the substrate loading chamber (not shown) through a return section. Here, only one carrier is illustrated in FIG. 1, but example embodiments are not limited thereto. The returnable transport movement may also be achieved by a plurality of carriers.

Referring to FIGS. 1 and 4, the mask 30 may be integrally formed by welding a sheet 32 having a plurality of pattern slits 33 arranged in the second direction Y on a rectangular metal frame 31. In order to reduce or substantially prevent thermal expansion, the metal frame 31 of the mask 30 may include a steel use stainless (SUS) based material or a 64FeNi material. The sheet 32 may also include a metal material, but example embodiments are not limited thereto.

The organic material discharged from the deposition source 40 passes through nozzles of the deposition source 40 and the pattern slits 33 of the mask 30 to then be deposited on the substrate 23. Here, an organic material pattern is formed on the substrate 23 according to positions of the pattern slits 33 on the sheet 32. The pattern slits 33 on the sheet 32 may be formed by a metal etching method, such as, for example, an FMM mask sheet. The mask 30 may be positioned between the substrate 23 and the deposition source 40 and may be disposed at a topmost layer 36 of the mask stage 35.

Referring to FIGS. 1 and 5, the mask stage 35 may align the position of the mask 30 with the substrate 23 in real time. The organic layer deposition apparatus 1 according to example embodiments performs organic layer deposition in a state in which the substrate 23 is maintained at a predetermined spatial interval from the sheet 32. Accordingly, the position of the mask 30 may be corrected to be aligned with the substrate 23 by controlling the mask stage 35 by measuring the position of the moving substrate 23 in real time.

The carrier 20 having the substrate 23 attached thereto may have a linear motion error being cause by the movement of the carrier 20. For example, traveling of the carrier 20 may cause a straightness error with respect to the first direction X (an error with respect to the second direction Y), a flatness error (an error with respect to the third direction Z), an error with respect to a yaw direction, an error with respect to a roll direction, an error with respect to a pitch direction, and the like. Here, the yaw direction is a direction in which the carrier 20 rotates about the axis of the third direction Z, the roll direction is a direction in which the carrier 20 rotates about the axis of the first direction X, and the pitch direction is a direction in which the carrier 20 rotates about the axis of the second direction Y.

The straightness error and the yaw-direction error of the carrier 20 cause alignment errors with the mask 30 in the second direction Y and the pitch direction, and the flatness error, the yaw-direction error and the roll-direction error of the carrier 20 cause alignment errors with the mask 30 in the third direction Z. In addition, the shapes of the substrate 23 attached to the electrostatic chuck 22 may not be planar due to a processing degree of a surface of the electrostatic chuck 22 of the carrier 20 and the weight of the substrate 23. That is to say, the gap between the mask 30 and the substrate 23 may be changed in real time due to the traveling error of the carrier 20 and the shapes of the substrate 23 attached to the electrostatic chuck 22.

Therefore, in order to deposit an organic material on a desired position on the substrate 23 when the substrate 23 is moved, it is necessary to align the substrate 23 and the mask 30 in real time on a 3D manner with respect to the traveling error of the substrate 23 and the non-planar shapes of the substrate 23. Here, the mask stage 35 may be configured to have 5-axes degrees of freedom, including degrees of freedom with respect to the second direction, the third direction and degrees of freedom with respect to directions rotating about axes of the yaw, roll and pitch directions, or 6-axes degrees of freedom, including degrees of freedom with respect to the first direction X, the second direction Y, the third direction Z, and degrees of freedom with respect to directions rotating about axes of the yaw, roll and pitch directions. However, for the sake of convenient explanation, the example embodiments will be described with regard to a case where the mask stage 35 has 5-axes degrees of freedom.

The mask stage 35 is divided into stages 37a, 37b and 37c operating in the third direction Z, and stages 38a and 38b operating in the XY-directions (i.e., in the first and second directions) to compensate for a linear traveling error of the carrier 20. In addition, the mask stage 35 may control the position of the mask 30 based on alignment errors with respect to the second direction Y and the yaw direction, measured by the camera 60, among the alignment errors between the substrate 23 and the mask 30, and may control the position of the mask 30 based on the flatness error, the pitch-direction error and the roll-direction error, measured by the distance measuring sensor 50. A controlling cycle for compensating for the position of the mask 30 may be, for example, 1 Hz or greater, or in a range of 3 Hz to 7 Hz.

Referring to FIGS. 1 and 6, the deposition source 40 may be positioned under the mask stage 35 in the vacuum chamber (not shown) and may store a material such as, for example, an organic material, therein.

For example, the deposition source 40 may include a crucible 42 for storing an organic material therein, a heater (not shown) supplying heat to the organic material, and a nozzle 41 for controlling the position and direction of a deposition material.

The deposition source 40 is configured to heat the stored organic material to be evaporated. The organic material heated in the deposition source 40 is emitted through the nozzle 41 under the pressure of 1×10⁻⁵ Pa or less and at an evaporation or sublimation temperature. The nozzle 41 is disposed such that the evaporated organic material faces the mask 30, and the organic material having passed through the nozzle 41 is discharged toward the mask 30.

Referring to FIG. 7, the distance measuring sensor 50 and the camera 60 may be positioned on the mask 30 to measure alignment errors between the substrate 23 and the mask 30.

For example, the substrate 23 is conveyed to below the distance measuring sensor 50 and the camera 60, and the distance measuring sensor 50 may include a plurality of sub-distance measuring sensors and may measure a flatness error, a pitch-direction error and a roll-direction error. In addition, the camera 60 may include a plurality of cameras, and the plurality of cameras may be arranged on edges of the mask 30 together with the respective illumination devices (not shown) to measure a straightness error and a yaw-direction error. In addition, the cameras 60 may measure alignment errors between the substrate 23 and the mask 30 by simultaneously or contemporaneously measuring an alignment mark (not shown) of the substrate 23 and an alignment mark (not shown) of the mask 30.

Here, the distance measuring sensor 50 may include one of a confocal sensor, a laser triangulation sensor, a spectral-interference laser displacement sensor, an eddy current sensor, and a capacitive sensor, but example embodiments are not limited thereto.

Referring to FIG. 8, a portion of a controller 155 connected to the distance measuring sensor 50 shown in FIG. 7 is illustrated.

For example, the distance measuring sensor 50 may be connected to a sensor controller 52 of the controller 155 and the sensor controller 52 may be connected to an electronic device (e.g., a processor, computer or PC) 54 for processing data.

The controller 155 will later be described in more detail with reference to FIG. 22.

Referring to FIGS. 9 and 10, layout views of the distance measuring sensor 50 are illustrated. The layout views of the distance measuring sensor 50 illustrated in FIGS. 9 and 10 are provided only for illustration, but example embodiments are not limited thereto. That is to say, the number of sub-distance measuring sensors 50-1 to 50-8 may be smaller or greater. However, for the sake of convenient explanation, the distance measuring sensor 50 including 8 sub-distance measuring sensors 50-1 to 50-8 will be described by way of example.

In the example embodiment illustrated in FIG. 9, the distance measuring sensor 50 may include 8 sub-distance measuring sensors 50-1 to 50-8. One of the first and second sub-distance measuring sensors 50-1 and 50-2 may be removable and one of the seventh and eighth sub-distance measuring sensors 50-7 and 50-8 may be removable. However, the third to sixth sub-distance measuring sensors 50-3 to 50-6 may be fixedly positioned on the edges of the mask 30.

Controlling operations relative to the distance measuring sensor 50 and the mask stage 35 will now be described.

The mask stage 35 has different control modes according to positions of the substrate 23. For example, the mask stage 35 is controlled in a first control mode when the first to fourth sub-distance measuring sensors 50-1 to 50-4 sense the substrate 23 while moving and the fifth and sixth sub-distance measuring sensors 50-5 and 50-6 are switched off, in a second control mode when the third to sixth sub-distance measuring sensors 50-3 to 50-6 sense the substrate 23, and in a third control mode when the third and fourth sub-distance measuring sensors 50-3 and 50-4 are switched off and the fifth to eighth sub-distance measuring sensors 50-5 to 50-8 sense the substrate 23. Here, the control mode refers to a mode in which the position of the mask stage 35 is controlled based on position values of the substrate 23, measured by the respective sub-distance measuring sensors 50-1 to 50-8. Here, a least square plane is formed by the position values measured by the respective sub-distance measuring sensors 50-1 to 50-8, thereby forming an imaginary reference control plane.

The respective sub-distance measuring sensors 50-1 to 50-8 measure positions of the mask 30 and the substrate 23.

For example, before the substrate 23 is provided at the mask 30, the third to sixth sub-distance measuring sensors 50-3 to 50-6 measure the position of the mask 30. Here, a measurement error may be generated due to roughness of a top surface of the mask 30. The position of the mask 30 may be determined based on the average value of data measured by scanning the top surface of the mask 30 as a measurement target. Here, the mask stage 35 moves in a rotating direction about the axis of the second direction Y or the third direction Z (i.e., in the yaw direction) to move the mask 30, thereby measuring the position of the mask 30 using the distance measuring sensor 50.

In addition, the distance measuring sensor 50 measures only the positions of the substrate 23 when the substrate 23 is over the mask 30 and passes through the mask 30. For example, the positions of the substrate 23 are determined by measuring the positions of the substrate 23 from a top surface or a bottom surface of the substrate 23. Here, the distance measuring sensor 50 may not simultaneously or contemporaneously measure positions of the mask 30 and the substrate 23 because a distance measurement error may increase when a distance between the mask 30 and the substrate 23 is reduced. In addition, roughness of the top surface of the mask 30 may cause a position measurement error of the mask 30.

The distance measuring sensor 50 may measure positions of the mask 30 and the substrate 23 and may provide the measured position data to the controller (155 of FIG. 2). The controller (155 of FIG. 2) may calculate a position control input value of the mask stage 35 based on the positions of the mask 30 and the substrate 23. Here, the positions of the substrate 23 may be determined by values measured in real time by the distance measuring sensor 50. The position of the mask 30 may be determined by referring to a position of an encoder of the mask stage 35 based on the value measured by the distance measuring sensor 50 before the substrate 23 passes over the mask 30.

In view of the above, in order to calculate the gap between the mask 30 and the substrate 23, first, the third to sixth sub-distance measuring sensors 50-3 to 50-6 measure an initial position of the mask 30 before the substrate 23 is admitted down to the first and second sub-distance measuring sensors 50-1 and 50-2. In addition, in order to maintain the gap between the mask 30 and the substrate 23, while the mask stage 35 moves in the control cycle, the position of the mask 30 may be updated in each control stage based on the encoder values of driving units (37a to 37c of FIG. 5) of the third direction Z-axis.

That is to say, in the first control mode, the gap between the mask 30 and the substrate 23 may be controlled based on a control plane with respect to the positions of the substrate 23, measured by the first to fourth sub-distance measuring sensors 50-1 to 50-4, and a control plane with respect to the position of the mask 30, measured by the third to sixth sub-distance measuring sensors 50-3 to 50-6.

Here, the measured values of the first to fourth sub-distance measuring sensors 50-1 to 50-4 or the third to sixth sub-distance measuring sensors 50-3 to 50-6 form a control plane with a least square plane.

In the second control mode, the gap between the mask 30 and the substrate 23 may be controlled based on a control plane with respect to the positions of the substrate 23, measured by the third to sixth sub-distance measuring sensors 50-3 to 50-6, and a control plane with respect to the position of the mask 30, initially measured by the third to sixth sub-distance measuring sensors 50-3 to 50-6 (that is, measured before the substrate 23 is over the mask 30).

In the third control mode, the gap between the mask 30 and the substrate 23 may be controlled based on a control plane with respect to the positions of the substrate 23, measured by the fifth to eighth sub-distance measuring sensors 50-5 to 50-8, and a control plane with respect to the position of the mask 30, initially measured by the third to sixth sub-distance measuring sensors 50-3 to 50-6.

As described above, when distance measuring sensor 50 measures the positions of the substrate 23, positions from both of the top and bottom surfaces of the substrate 23 may be measured. Specifically, when the position of the top surface of the substrate 23 is measured, the control plane is formed based on a width in the third direction Z of the substrate 23.

In view of the above, the aforementioned control modes are provided by way example and may vary according to the number of sub-distance measuring sensors arranged. However, in order to form a control plane in each control mode, at least three sub-distance measuring sensors may be used. Here, the control plane means an imaginary plane formed by measured values acquired by the distance measuring sensor 50. That is to say, a control plane formed by three sub-distance measuring sensors forms a plane passing three points, and a control plane formed by four or more sub-distance measuring sensors forms a least square plane for four or more measured points.

Additionally, the accuracy of the control plane can be increased by increasing the number of sub-distance measuring sensors in each control mode.

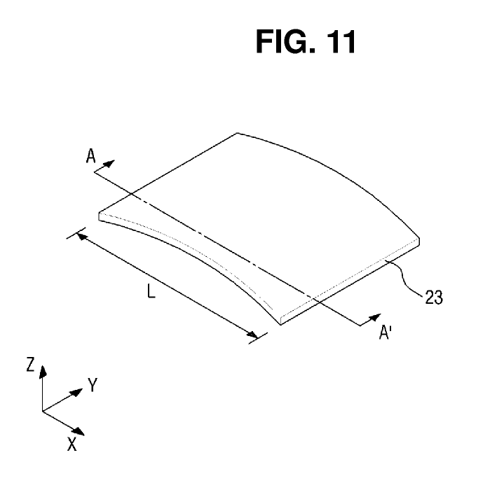

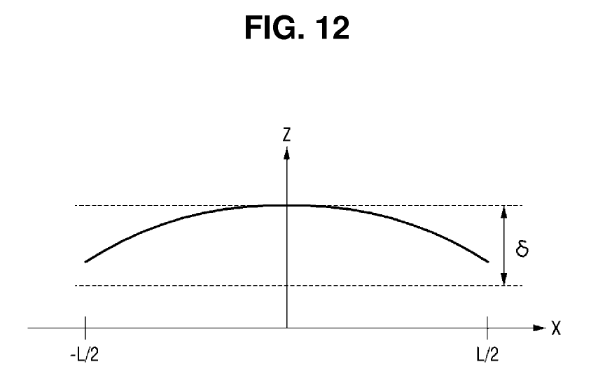

Hereinafter, the shape of a substrate will be described with reference to FIGS. 11 and 12.

FIGS. 11 and 12 are diagrams illustrating a case in which a substrate shown in FIG. 1 is not planar.

The substrate 23 attached to the electrostatic chuck 22 of the carrier 20 may not be ideally planar, like in FIG. 1.

That is to say, when the substrate 23 is assembled with the carrier 20, the electrostatic chuck 22 may have flatness tolerance with respect to a plane attached to the substrate 23. In addition, the substrate 23 attached to the electrostatic chuck 22 of the carrier 20 may not be actually planar due to the weight and thermal stress deformation of the carrier 20.

FIG. 11 illustrates the substrate 23 being in a non-planar state for the foregoing reason, and FIG. 12 illustrates a sectional view of the substrate 23, taken along the line AA′. For example, assuming that the substrate 23 has a length L, the substrate 23 may be shaped to have a displacement (bend) 8.

The length L and displacement 8 of the substrate 23 shown in FIG. 12 are provided only for illustration. Unlike in FIG. 12, the substrate 23 may be bent (that is, displaced) more at one side thereof than the other side thereof.

According to example embodiments, the substrate is conveyed through a plurality of carrier returnable transport systems, and the shape of a glass substrate may vary according to the kinds of carriers. In addition, the shapes of the substrate for the same carrier may vary according to deformation of the carrier over time.

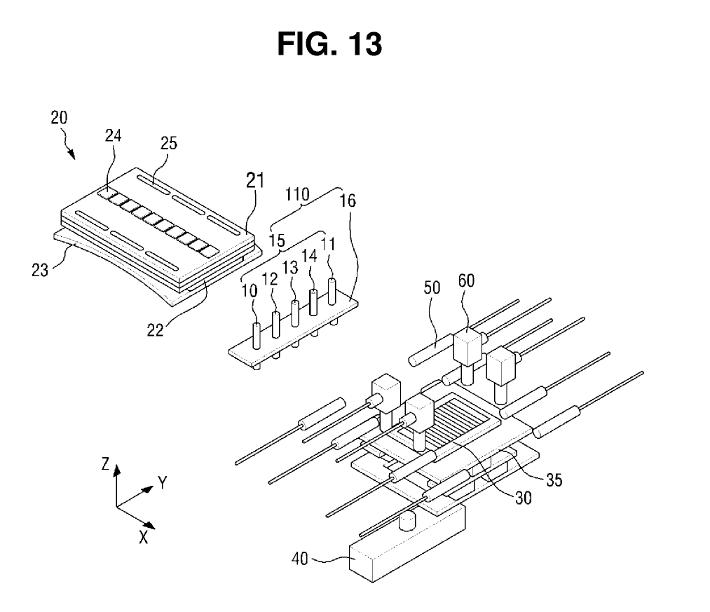

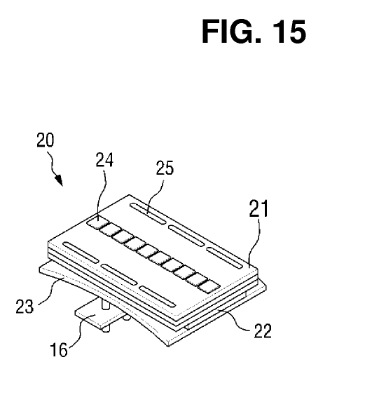

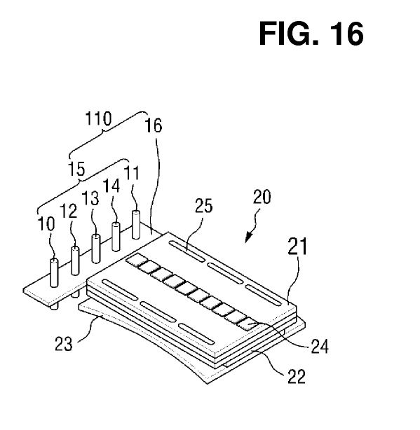

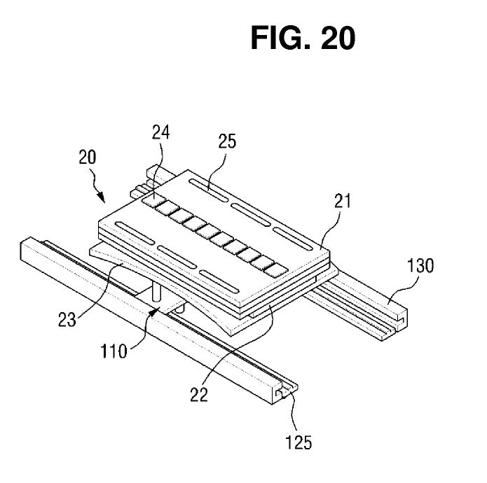

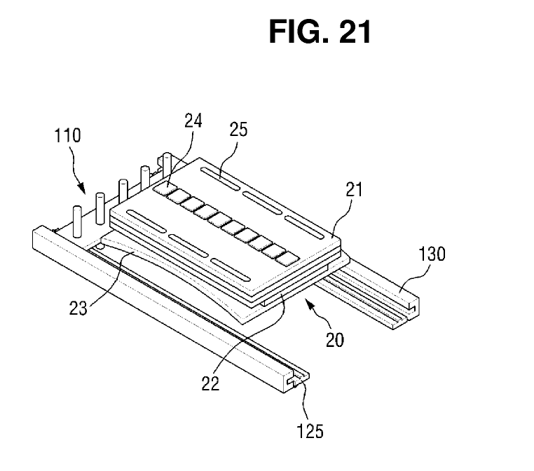

Hereinafter, a shape measuring sensor shown in FIG. 1 will be described with reference to FIGS. 13 to 21.

FIGS. 13 to 21 are diagrams of a shape measuring sensor shown in FIG. 1.

Referring to FIG. 13, a layout view of the shape measuring sensor for measuring the shapes of the substrate 23 is illustrated. FIG. 13 illustrates a case of measuring the shapes of the substrate 23 while fixing the shape measuring sensor 110 and moving the carrier 20.

That is to say, according to this example method for measuring the shapes of the substrate 23 while fixing the shape measuring sensor 110 and moving the carrier 20, a plurality of sensors 15 of the shape measuring sensor 110 are arranged in a line and the fixed plurality of sensors 15 measure a surface of the substrate 23 attached to the moving carrier 20, thereby acquiring shape data of the substrate 23.

For example, the shape measuring sensor 110 for measuring the shapes of the substrate 23 includes the plurality of sensors 15 arranged in one line to be fixed to a jig 16 so as to face a third direction Z. A column, on which the respective sensors 10 to 14 are positioned, extends in a direction (i.e., in a second direction Y) perpendicular to a moving direction of the substrate 23 (i.e., a first direction X). The number of sensors included in the shape measuring sensor 110 may be 2 or greater so as to correspond to a size of the substrate 23.

In particular, the shape measuring sensor 110 may include two sensors 10 and 11 capable of measuring outermost lines of the substrate 23. The two sensors 10 and 11 may be arranged in the second direction Y at the same position as the distance measuring sensor 50 for controlling the mask stage 35.

Sensors (e.g., 12, 13 and 14) positioned between the outermost sensors 10 and 11 may include a plurality of sensors so as to cover the size of the substrate 23. In addition, the plurality of sensors 15 included in the shape measuring sensor 110 may be spaced an equal interval, or a different interval, apart from each other.

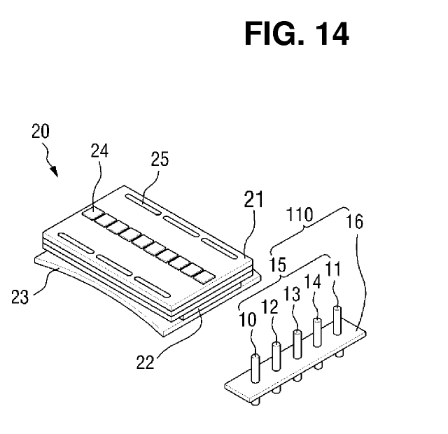

FIGS. 14 to 16 illustrate the method and sequence for measuring the shapes of the substrate 23 using the shape measuring sensor 110 shown in FIG. 13. That is to say, the plurality of sensors 15, including the outermost sensors 10 and 11, are fixed to the jig 16, and as illustrated in FIGS. 14 to 16, the shapes of the substrate 23 are measured while the substrate 23 moves over the shape measuring sensor 110.

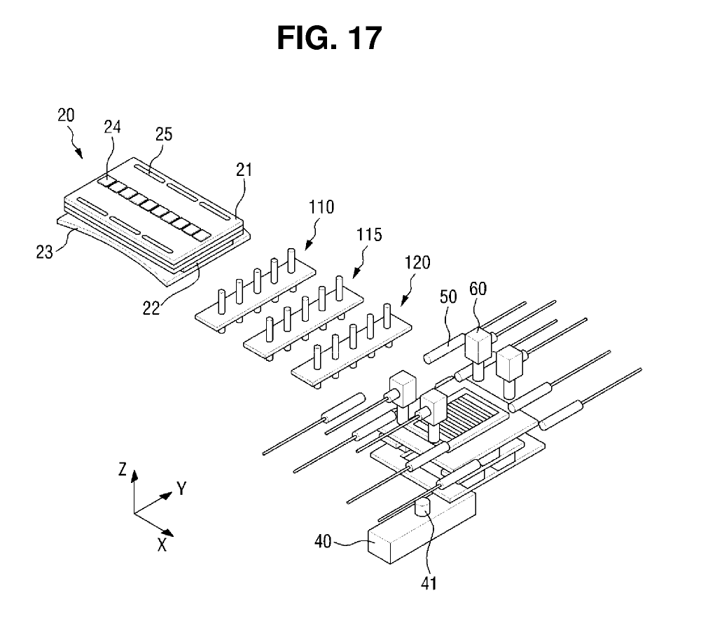

Referring to FIG. 17, a layout view of the shape measuring sensor for measuring the shapes of the substrate 23 is illustrated. FIG. 17 illustrates a case of measuring the shape of the substrate 23 while fixing the shape measuring sensor 110 and stopping the carrier 20.

As illustrated in FIG. 17, according to this example method of measuring the shapes of the substrate 23 while fixing the shape measuring sensor 110 and stopping the carrier 20, the shapes of the substrate 23 are measured using a plurality of sensors 110, 115 and 120 arranged in an N×M matrix (N may be an integer of 3 or greater and M may be an integer of 2 or greater) in a state in which the carrier 20 is stopped and fixed to a lower portion of the carrier 20.

For example, the plurality of shape measuring sensors 110 are arranged so as to correspond to a size of the substrate 23. For example, the plurality of shape measuring sensors 110 may include, for example, three or more shape measuring sensors 110, and each of the shape measuring sensors 110 may include at least two sensors capable of measuring outermost lines of the substrate 23.

According to the example method of measuring the shapes of the substrate 23 while fixing the shape measuring sensor 110 and stopping the carrier 20 illustrated in FIG. 17, the carrier 20 is stopped to correspond to the plurality of sensors 15 arranged in a matrix, and shape data of the substrate 23 is then acquired. For example, discrete data concerning the shapes of the substrate 23 can be acquired according to the number and arrangement of sensors. In order to acquire continuous data of the shapes of the substrate 23, a curve fitting process using the measured discrete data may be performed.

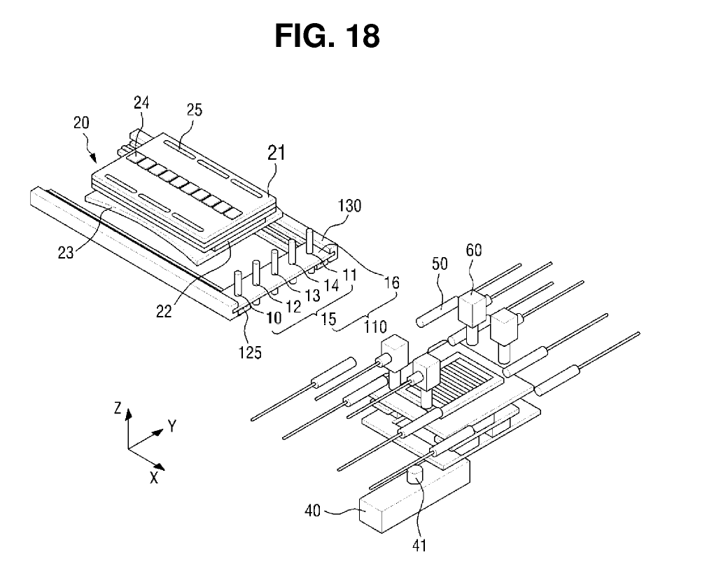

Referring to FIG. 18, a layout view of the shape measuring sensor for measuring the shapes of the substrate 23 is illustrated. FIG. 18 illustrates an example of measuring shapes of the substrate 23 while moving the shape measuring sensor 110 and stopping the carrier 20.

According to this example method of measuring the shapes of the substrate 23 while moving the shape measuring sensor 110 and stopping the carrier 20, the shapes of the substrate 23 are measured by moving the shape measuring sensor 110 including a plurality of sensors arranged in a line in a state in which the carrier 20 is stopped.

In FIG. 18, as described above, in order to measure the shapes of the substrate 23, the plurality of sensors 15 arranged in one line are fixed to a jig 16 so as to face a third direction Z. A column, on which the plurality of sensors 15 are positioned, extends in a direction (i.e., in a second direction Y) perpendicular to a moving direction of the substrate 23 (i.e., a first direction X). The number of the plurality of sensors 15 may be 2 or greater so as to correspond to a size of the substrate 23.

In this case, the shape measuring sensor 110 may include at least two sensors 10 and 11 configured to measure outermost lines of the substrate 23. In addition, sensors (e.g., 12, 13 and 14) positioned between the outermost sensors 10 and 11 may include a plurality of sensors so as to correspond to the size of the substrate 23. In addition, the outermost sensors 10 and 11 and the sensors (e.g., 12, 13 and 14) positioned between the outermost sensors 10 and 11 may be spaced an equal interval, or a different interval, apart from each other.

Additionally, the organic layer deposition apparatus 1 according to an example embodiment may further include a driving unit 125 and a guide unit 130 to allow the shape measuring sensor 110 to reciprocate in a first direction X.

The driving unit 125 may allow the shape measuring sensor 110 to reciprocate in the first direction X and the guide unit 130 may guide the driving unit 125 in the first direction X.

For example, the guide unit 130 may include a slide groove extending in the first direction X and opposite ends of the jig 16 of the shape measuring sensor 110 may be engaged with the slide groove of the guide unit 130. Accordingly, the shape measuring sensor 110 may more stably move along the guide unit 130 when the shape measuring sensor 110 is moved by the driving unit 125.

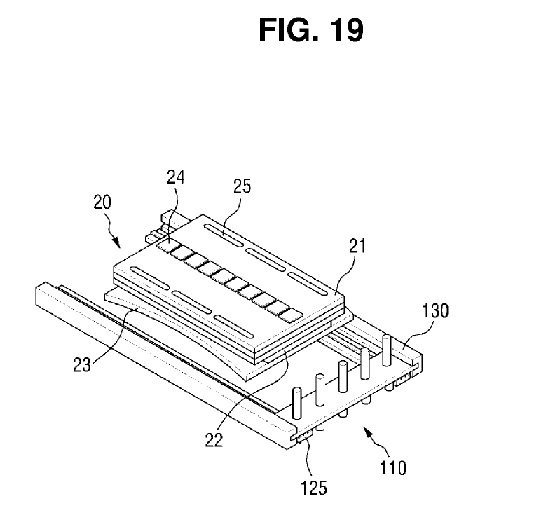

FIGS. 19 to 21 illustrate the method and sequence for measuring the shapes of the substrate 23 using the shape measuring sensor 110 shown in FIG. 18. For example, if the carrier 20 having the substrate 23 attached thereto is stopped, the shape measuring sensor 110 measures a surface of the substrate 23 while being moved along the guide unit 130 in the first direction X by the driving unit 125, and if the measuring of the shapes of the substrate 23 is completed, the shape measuring sensor 110 returns back to a position shown in FIG. 19.

Hereinafter, a controller controlling the mask stage shown in FIG. 1 will be described with reference to FIG. 22.

FIG. 22 is a schematic diagram of a controller controlling the mask stage shown in FIG. 1.

For example, the controller 155 may include a first sensor controller 51 controlling the shape measuring sensor 110 and receiving data measured by the shape measuring sensor 110, a substrate shape measuring device (e.g., a processor, computer or PC) 161 storing the data received from the first sensor controller 51 for each substrate ID, a second sensor controller 52 controlling the distance measuring sensor 50 and receiving data measured by the distance measuring sensor 50, an electronic device (e.g., a processor, computer or PC) 54 for processing the data received from the second sensor controller 52, a vision board 164 controlling a camera 60, and a light controller 165 controlling an illumination device 61 disposed next to the camera 60.

The data for each substrate ID stored in the substrate shape measuring device 161 is supplied to the electronic device 54, and the electronic device 54 may control the mask stage 35 based on the data received from the substrate shape measuring device 161 and the data received from the camera 60 and the distance measuring sensor 50.

An example process of the controller 155 controlling the mask stage will now be briefly described. First, the shape measuring sensor 110 controlled by the first sensor controller 51 measures the shapes of the substrate 23. Next, the shape measuring sensor 110 supplies the shape measurement data to the substrate shape measuring device 161 through the first sensor controller 51. The substrate shape measuring device 161 stores the shape measurement data received from the first sensor controller 51 on an ID basis of the substrate 23. If the substrate 23 is moved down to the distance measuring sensor 50, the mask stage 35 controls a gap between the substrate 23 and the mask 30 based on the data received from the electronic device 54 (the data received from the substrate shape measuring device 161 and the data received from the camera 60 and the distance measuring sensor 50).

Relative positions of the substrate 23 and the mask 30 are measured by the camera 60 and the distance measuring sensor 50. Accordingly, an alignment error between the mask 30 and the substrate 23, measured by the camera 60, is supplied to the electronic device 54. The electronic device 54 controls stages Y1-axis 38a and Y2-axis 38b operating in XY-directions of the mask stage 35 (i.e., first and second directions) based on data of the alignment error received from the camera 60, and aligns the mask stage 35 on an X-Y plane. That is to say, the alignment error of the second direction Y and a rotation error with respect to the third direction Z may be compensated for by using the data measured by the camera 60. In addition, an alignment error between the mask 30 and the substrate 23, measured by the distance measuring sensor 50, is supplied to the electronic device 54. The electronic device 54 may control stages Z1-axis 37a, Z2-axis 37b and Z3-axis 37c operating in the third direction Z of the mask stage 35 based on the data of the alignment error received from the distance measuring sensor 50 and may align the mask stage 35. That is to say, the mask stage 35 is moved in rotation directions with respect to the third direction Z and the first direction X and in a rotation direction with respect to the second direction Y using values measured by the distance measuring sensor 50, thereby controlling an error in the gap between the mask 30 and the substrate 23.

Additionally, the electronic device 54 feeds back a value of an encoder to the mask stage 35, thereby more accurately controlling the position of the mask stage 35.

The organic layer deposition apparatus 1 according to an example embodiment includes the shape measuring sensor 110 can improve the accuracy of the gap between the substrate 23 and the mask 30 based on the shapes of the substrate 23 during the control process of controlling the position of the mask stage 35 by pre-measuring the shapes of the substrate 23 before the organic layer deposition is started. In addition, the organic layer deposition apparatus 1 includes the distance measuring sensor 50 measuring an initial position of the mask 30 and the positions of the substrate 23, thereby reducing a measurement error of a surface of the mask 30 and further improving the accuracy of the gap between the substrate 23 and the mask 30 by pre-measuring the position of the mask 30 and averaging the measured values.

Hereinafter, an operating method of the example organic layer deposition apparatus shown in FIG. 1 will be described with reference to FIGS. 1, 9 and 23.

Referring to FIGS. 1, 9 and 23, first, the substrate 23 is loaded (S100).

For example, the substrate 23 is mounted on the electrostatic chuck 22 such that a top surface of the substrate 23 faces upward in a substrate loading chamber (not shown). The substrate 23 mounted on the electrostatic chuck 22 is aligned and then attached to the electrostatic chuck 22 as the electrostatic chuck 22 is turned on. The carrier 20 having the substrate 23 attached thereto is inverted upside down to then proceed in the first direction X along a transport line (not shown).

The shapes of the substrate 23 are measured (S105).

For example, the shape measuring sensor 110 may measure the shapes of the substrate 23 before an organic layer is deposited on the substrate 23. The shapes of the substrate 23 measured by the shape measuring sensor 110 is classified by substrate ID to then be stored in the substrate shape measuring device 161 of the controller 155.

The mask stage 35 is allowed to wait at a safe position (SI 10).

For example, the distance measuring sensor 50 measures the position of the mask 30 before the substrate 23 passes through the mask 30. Here, in order to minimize a measurement error generated due to roughness of a top surface of the mask 30, the distance measuring sensor 50 determines a measurement position of the mask 30 by scanning the surface of the mask 30 to a length of at least 0.01 mm and obtaining an average value of scanned values. The position of the mask 30 is firstly measured just one time before the mark 30 is provided on the substrate 23. Thereafter, the position of the mask stage 35 is moved on the basis of a signal of the encoder incorporated into the mask stage 35. If the distance measuring sensor 50 completes the measuring of the position of the mask 30, the mask stage 35 is allowed to wait at a safe position. Here, the safe position means a position of the mask 30, at which collision between the mask 30 and the substrate 23 can be easily avoided. In general, the safe position may have a margin in a range of 0.1 mm to 1 mm from a bottom surface of the substrate 23 but may be adjusted according to the measurement range of the distance measuring sensor 50.

The first and second sub-distance measuring sensors 50-1 and 50-2 are turned on (S115).

For example, the first and second sub-distance measuring sensors 50-1 and 50-2, which are closest to a position where the substrate 23 is loaded to proceed to the deposition source 40 by the carrier 20, are turned on for the first time.

The mask stage 35 is moved to a control-ready position (S120).

For example, if the first and second sub-distance measuring sensors 50-1 and 50-2 sense the admission of the substrate 23, the mask stage 35 moves to the control-ready position. Here, the control-ready position may be closer to the distance measuring sensor 50 than the safe position. However, the organic material having passed through the mask 30 needs to be deposited on the substrate 23 so as to coincide with a predetermined pattern. Accordingly, the control-ready position may be positioned to be spaced apart from the admitted substrate 23 so as not to make contact with the substrate 23.

The third and fourth sub-distance measuring sensors 50-3 and 50-4 are turned on (S125).

For example, if the mask stage 35 moves to the control-ready position, the third and fourth sub-distance measuring sensors 50-3 and 50-4 may be turned on.

The mask stage 35 is controlled to be at a first position (S130).

For example, if the third and fourth sub-distance measuring sensors 50-3 and 50-4 sense the admission of the substrate 23, the mask stage 35 controls the gap between the substrate 23 and the mask 30 in the first control mode based on position values of the substrate 23 measured by the first to fourth sub-distance measuring sensors 50-1 to 50-4. The distance measuring sensor 50 measures only the positions of the substrate 23 and the positions of the substrate 23 may be measured from a top surface or a bottom surface of the substrate 23. In the first control mode, the gap between the substrate 23 and the mask 30 is controlled based on the position data of the substrate 23 and the data of the pre-measured shape of the substrate 23.

The third to sixth sub-distance measuring sensors 50-3 to 50-6 are turned on (S135).

For example, after the first control mode is completed, the third to sixth sub-distance measuring sensors 50-3 to 50-6 may be turned on.

The mask stage 35 is controlled to be at a second position (S140).

For example, if the third to sixth sub-distance measuring sensors 50-3 to 50-6 sense the admission of the substrate 23, the mask stage 35 controls the gap between the substrate 23 and the mask 30 in the second control mode based on position values of the substrate 23 measured by the third to sixth sub-distance measuring sensors 50-3 to 50-6.

The third and fourth sub-distance measuring sensors 50-3 and 50-4 are turned off and the fifth to eighth sub-distance measuring sensors 50-5 to 50-8 are turned on (S145).

For example, after the second control mode is completed, the substrate 23 passes through the third and fourth sub-distance measuring sensors 50-3 and 50-4, so that the admission of the substrate 23 is not sensed by the third and fourth sub-distance measuring sensors 50-3 and 50-4, the third and fourth sub-distance measuring sensors 50-3 and 50-4 may be turned off and the fifth to eighth sub-distance measuring sensors 50-5 to 50-8 may be turned on.

The mask stage 35 is controlled to be at a third position (S145).

For example, if the fifth to eighth sub-distance measuring sensors 50-5 to 50-8 sense the admission of the substrate 23, the mask stage 35 controls the gap between the substrate 23 and the mask 30 in the third control mode based on position values of the substrate 23 measured by the fifth to eighth sub-distance measuring sensors 50-5 to 50-8. In the third control mode, like in the first control mode, the gap between the substrate 23 and the mask 30 is controlled based on the position data of the substrate 23 and data of the pre-measured shape of the substrate 23.

The fifth and sixth sub-distance measuring sensors 50-5 and 50-6 are turned off (S155).

For example, if the admission of the substrate 23 is not sensed by the fifth and sixth sub-distance measuring sensors 50-5 and 50-6, the fifth and sixth sub-distance measuring sensors 50-5 and 50-6 are turned off.

The mask stage 35 is moved to a safe position (S160).

For example, after the fifth and sixth sub-distance measuring sensors 50-5 and 50-6 are turned off, the mask stage 35 moves to the safe position and controlling of the mask stage 35 is completed.

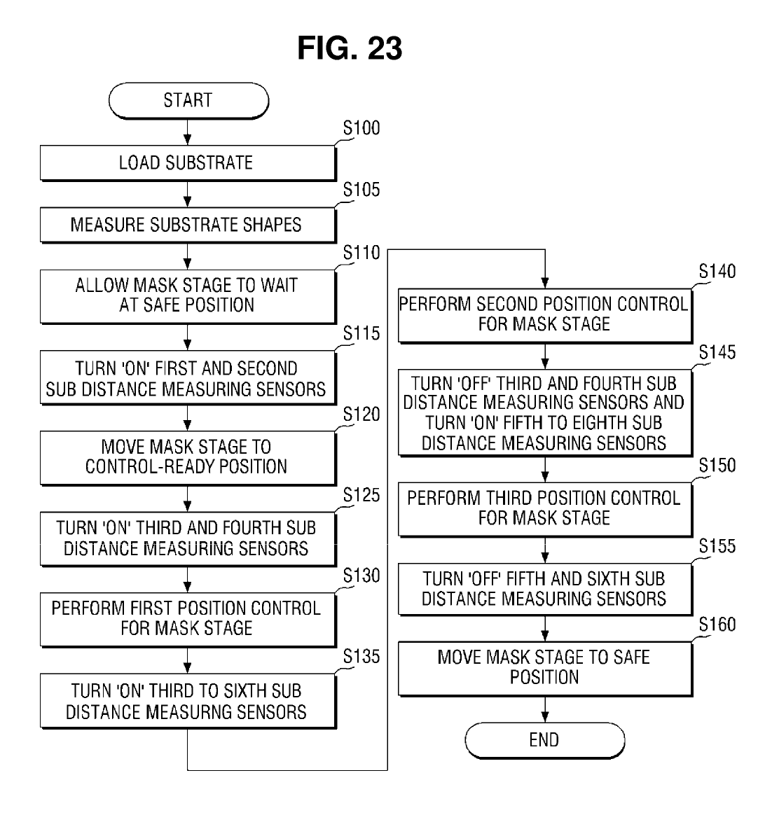

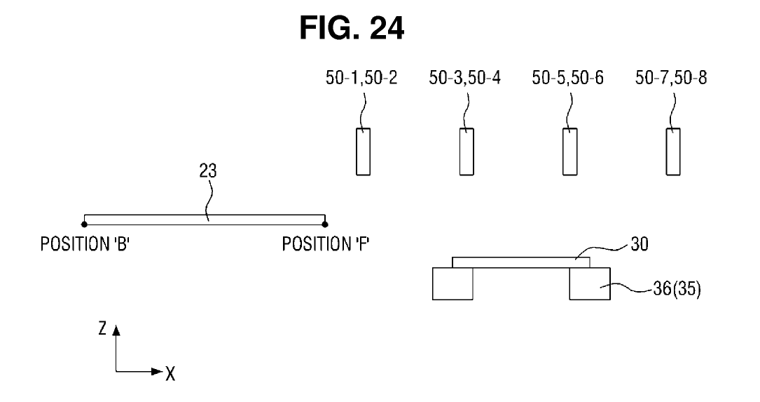

Hereinafter, an example in which the organic layer deposition apparatus operating method shown in FIG. 23 is applied to a non-planar substrate will be described with reference to FIGS. 24 to 28.

FIGS. 24 to 28 are diagrams illustrating an example of applying the organic layer deposition apparatus operating method shown in FIG. 23 to a non-planar substrate. However, for the sake of convenient explanation, it is assumed in FIGS. 24 to 28 that positions of the substrate 23 are measured from the bottom surface of the substrate 23.

Referring to FIGS. 1 and 24, a state in which the substrate 23 is at a position F before it is admitted down to the first and second sub-distance measuring sensors 50-1 and 50-2 is illustrated. Here, the mask stage 35 being at the safe position waits in a stop state.

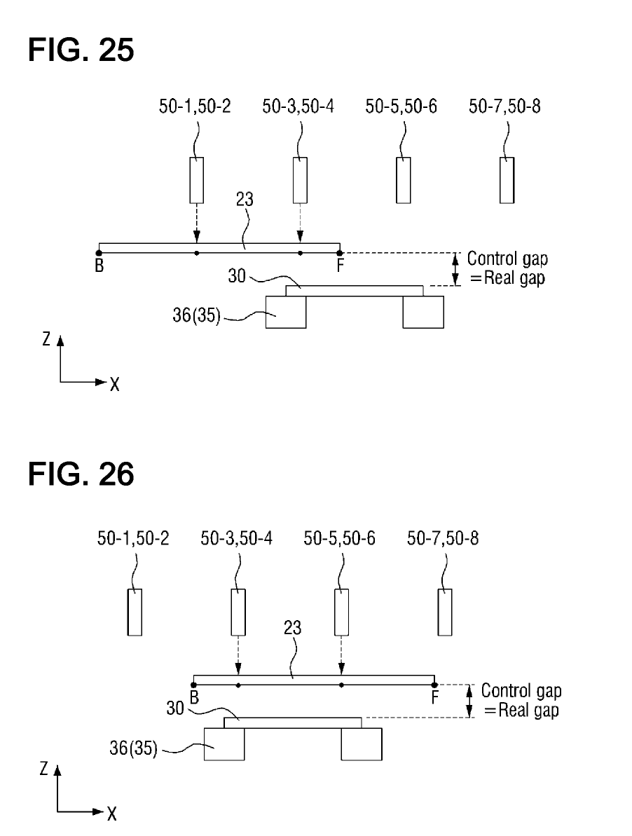

Referring to FIGS. 1 and 25, a case in which the substrate 23 is positioned under the first to fourth sub-distance measuring sensors 50-1 to 50-4 is illustrated. Here, the mask stage 35 is controlled in the first control mode in real time based on values measured by the first to fourth sub-distance measuring sensors 50-1 to 50-4.

Referring to FIGS. 1 and 26, a case in which the substrate 23 is positioned under the third to sixth sub-distance measuring sensors 50-3 to 50-6 is illustrated. Here, the mask stage 35 is controlled in the second control mode in real time based on values measured by the third to sixth sub-distance measuring sensors 50-3 to 50-6.

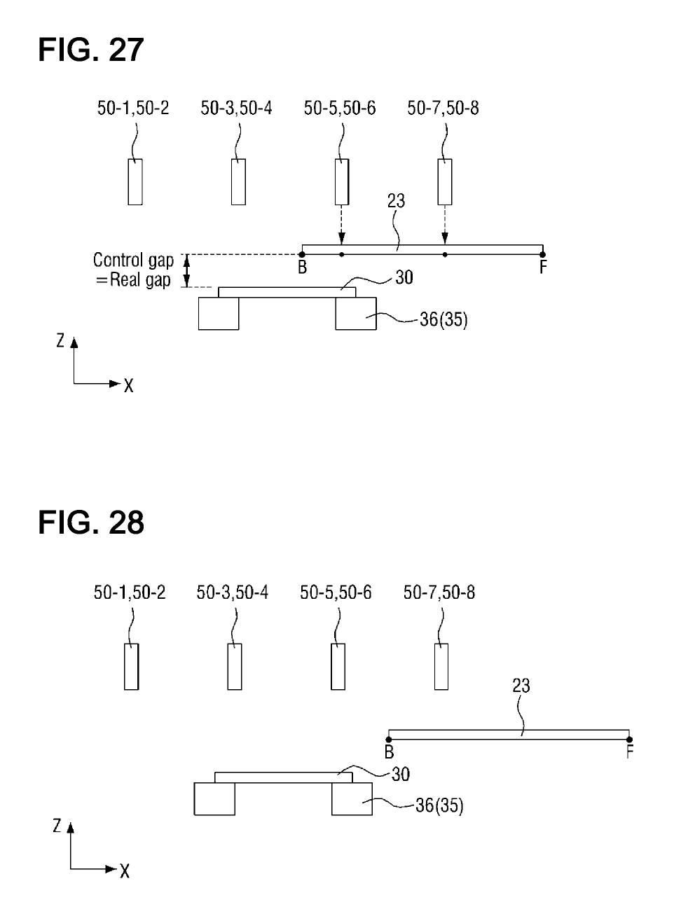

Referring to FIGS. 1 and 27, a case in which the substrate 23 is positioned under the fifth to eighth sub-distance measuring sensors 50-5 to 50-8 and the third and fourth sub-distance measuring sensors 50-3 and 50-4 are turned off is illustrated. Here, the mask stage 35 is controlled in the third control mode in real time based on values measured by the fifth to eighth sub-distance measuring sensors 50-5 to 50-8.

As illustrated in FIGS. 24 to 27, when the substrate 23 having a planar shape passes, the control gap and the real gap may be equal to each other. That is to say, when the substrate 23 is planar, the target gap between the mask 30 and the substrate 23 is maintained at a constant level. Therefore, when an organic layer pattern is formed on the planar substrate 23 in the three control modes, the gap between the substrate 23 and the mask can be constantly maintained even with changes in the positions of the substrate 23.

Referring to FIGS. 1 and 28, a state in which the substrate 23 is at a position B after it escapes from below the fifth and sixth sub-distance measuring sensors 50-5 and 50-6 is illustrated. In this case, the mask stage 35 moves to a safe position.

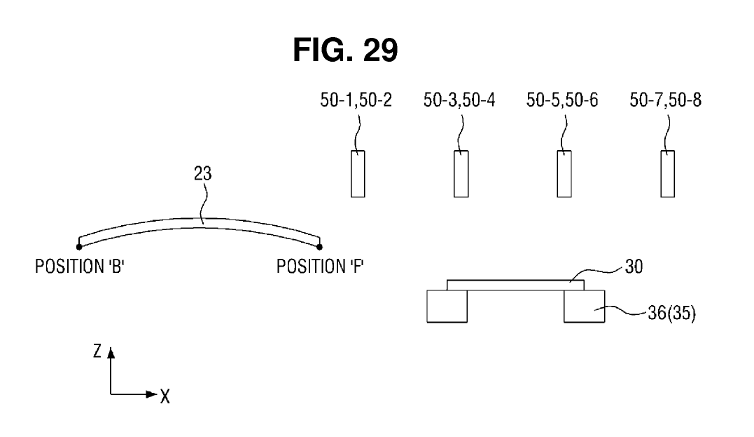

Hereinafter, a case of applying the operating method of the organic layer deposition apparatus shown in FIG. 23 to a non-planar substrate will be described with reference to FIGS. 29 to 33.

FIGS. 29 to 33 illustrate a control process of the mask stage 35 in a case in which the organic layer deposition apparatus operating method shown in FIG. 23 is applied to a non-planar substrate. However, for the sake of convenient explanation, it is assumed in FIGS. 29 to 33 that positions of the substrate 23 are measured from the bottom surface of the substrate 23.

Referring to FIGS. 1 and 29, a state in which the substrate 23 is at a position F before it is admitted down to the first and second sub-distance measuring sensors 50-1 and 50-2 is illustrated. Here, the mask stage 35 is stopped at a safe position.

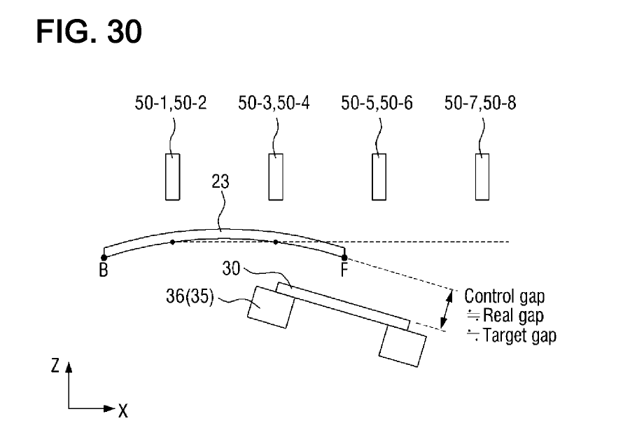

Referring to FIGS. 1 and 30, a case in which the substrate 23 passes through the third and fourth sub-distance measuring sensors 50-3 and 50-4 and a gap between the mask 30 and the substrate 23 is controlled in the first control mode is illustrated. Here, since the shape data of the substrate 23 is taken into consideration, the mask stage 35 may reduce an error in the target gap between the mask 30 and the substrate 23 by reflecting the shape data on the control gap even when the substrate 23 attached to the electrostatic chuck 22 is not planar. That is to say, a shape error of the substrate 23 can be removed based on a gap error generated due to the shapes of the substrate 23 on the control plane for the positions of the substrate 23, measured by the first to fourth sub-distance measuring sensors 50-1 to 50-4. Therefore, as illustrated in FIG. 30, the gap between the mask 30 and the substrate 23 when the substrate 23 is at the position F may be maintained such that the target gap and the real gap are equal to each other. Accordingly, the gap between the mask 30 and the substrate 23 may not be affected by the shape of the substrate 23.

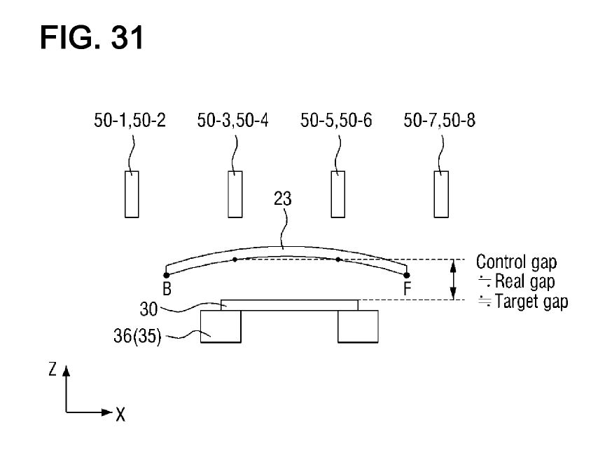

Referring to FIGS. 1 and 31, a case in which the substrate 23 is positioned under the third to sixth sub-distance measuring sensors 50-3 to 50-6 is illustrated. Here, the mask stage 35 is controlled in the second control mode in real time based on values measured by the third to sixth sub-distance measuring sensors 50-3 to 50-6. In the second control mode, based on four measurement points measured by the third to sixth sub-distance measuring sensors 50-3 to 50-6, a least square plane is formed as a control plane for controlling the mask stage 35.

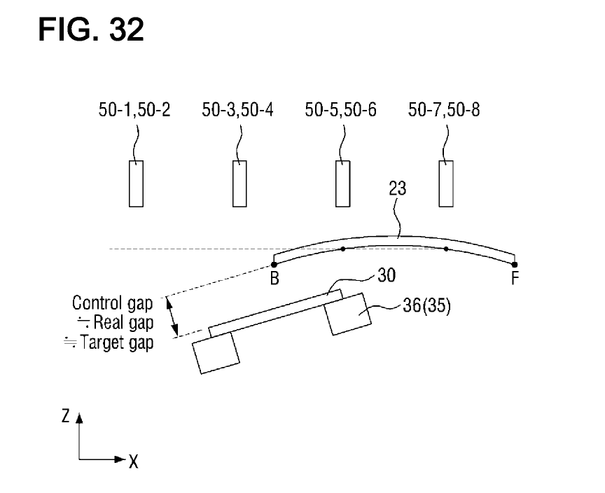

Referring to FIGS. 1 and 32, a case in which the substrate 23 is positioned under the fifth to eighth sub-distance measuring sensors 50-5 to 50-8 and the third and fourth sub-distance measuring sensors 50-3 and 504 are turned off is illustrated. Here, the mask stage 35 is controlled in the third control mode in real time based on values measured by the fifth to eighth sub-distance measuring sensors 50-5 to 50-8. In this case, even if the substrate 23 is not planar, an error in the target gap between the mask 30 and the substrate 23 may be reduced by reflecting the shape data of the substrate 23 on the control gap. That is to say, as illustrated in FIG. 32, when the non-planar substrate 23 passes in the third control mode, a gap between a top surface of the mask 30 and a bottom surface of the substrate 23 being at a position B is maintained such that the control gap and the target gap are equal to each other. Accordingly, the gap between the mask 30 and the substrate 23 may not be affected by the shape of the substrate 23. In the first control mode and the third control mode, shapes of the substrate 23 are reflected in real time in controlling the gap between the mask 30 and the substrate 23. Therefore, even if a non-planar substrate is at the mask 30, the gap between the mask 30 and the substrate 23 may be constantly maintained without being affected by the shape of the substrate 23.

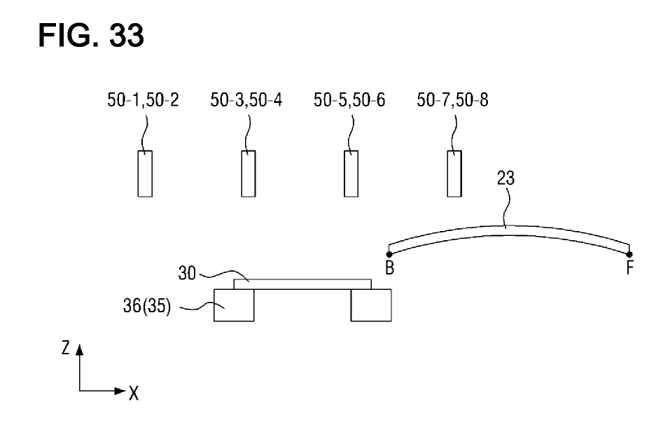

Referring to FIG. 33, a state in which the substrate 23 is at a position B after it escapes from below the fifth and sixth sub-distance measuring sensors 50-5 and 50-6 is illustrated. In this case, the mask stage 35 moves to a safe position.

While the example embodiments have been particularly shown and described, it will be understood by those of ordinary skill in the art that various changes in form and details may be made therein without departing from the spirit and scope of the example embodiments as defined by the following claims. It is therefore desired that the example embodiments be considered in all respects as illustrative and not restrictive, reference being made to the appended claims rather than the foregoing description to indicate the scope of the invention.

1. An apparatus for organic layer deposition on a substrate, the apparatus comprising:
a shape measuring sensor configured to measure shapes of the substrate;
a carrier configured to convey the substrate in a first direction;
a deposition source configured to discharge a deposition material to the substrate;
a mask between the substrate and the deposition source and including a plurality of pattern slits arranged in a second direction crossing the first direction;
a camera configured to measure an alignment error between the substrate and the mask and configured to measure a straightness of the carrier in the second direction;
a distance measuring sensor configured to measure an alignment error between the substrate and the mask and configured to measure flatness of the carrier in the third direction crossing the first and second directions; and
a mask stage configured to control a position of the mask based on the measured shapes of the substrate and the measured alignment error between the substrate and the mask,
wherein the organic layer deposition using the deposition source is performed when the substrate is conveyed by the carrier in the first direction and passes through a region between the mask and the distance measuring sensor.

2. The apparatus of claim 1, wherein the shape measuring sensor comprises a first sub shape measuring sensor including a first sensor and a second sensor arranged in the second direction.

3. The apparatus of claim 2, wherein the first and second sensors are arranged along outer lines spaced apart from each other in the second direction of the substrate and facing each other.

4. The apparatus of claim 2, wherein the first sub shape measuring sensor further includes a jig configured to fix the first and second sensors in the third direction.

5. The apparatus of claim 1, further comprising:
a driving unit configured to move the shape measuring sensor in the first direction; and
a guide unit configured to guide the driving unit in the first direction.

6. The apparatus of claim 1, wherein the carrier includes an electrostatic chuck configured to attach the substrate.

7. The apparatus of claim 1, wherein the mask stage has 5-axes degrees of freedom, and the 5-axes degrees of freedom include degrees of freedom with respect to the second direction and the third direction and degrees of freedom with respect to directions rotating about axes of the first direction to the third direction.

8. The apparatus of claim 1, wherein the camera is configured to measure an error with respect to the second direction and an error with respect to a direction rotating about the axis of the second direction between the substrate and the mask.

9. The apparatus of claim 8, wherein the camera is configured to measure alignment errors between the substrate and the mask by contemporaneously measuring an alignment mark of the substrate and an alignment mark of the mask.

10. The apparatus of claim 1, wherein the distance measuring sensor is configured to measure an error with respect to the third direction and an error with respect to a direction rotating about the axis of each of the first and third directions among alignment errors between the substrate and the mask.

11. The apparatus of claim 1, wherein at least one of the shape measuring sensor and the distance measuring sensor includes one of a confocal sensor, a laser triangulation sensor, a spectral-interference laser displacement sensor, an eddy current sensor, and a capacitive sensor.

12. The apparatus of claim 1, wherein the camera includes a plurality of cameras, and the plurality of cameras are positioned on edges of the mask.

13. The apparatus of claim 1, wherein the distance measuring sensor includes first to fourth sub-distance measuring sensors, and the first to fourth sub-distance measuring sensors are on edges of the mask.

14. The apparatus of claim 13, wherein the first and second sub-distance measuring sensors face each other in the first direction, the third and fourth sub-distance measuring sensors face each other in the first direction, and the first and second sub-distance measuring sensors face the third and fourth sub-distance measuring sensors in the second direction.

15. An apparatus for organic layer deposition for forming an organic layer on a substrate, the apparatus comprising:
a shape measuring sensor at a bottom end of the substrate and configured to measure shapes of the substrate;
a carrier configured to convey the substrate in a first direction;
a deposition source configured to discharge a deposition material to the substrate;
a mask between the substrate and the deposition source and including a plurality of pattern slits arranged in a second direction crossing the first direction;
a distance measuring sensor configured to measure alignment errors between the substrate and the mask; and
a mask stage configured to control a position of the mask based on the measured shapes of the substrate and the measured alignment errors between the substrate and the mask,
wherein the shape measuring sensor includes first and second sensors arranged in the second direction, and the first and second sensors are spaced apart from each other in the second direction of the substrate and arranged along outer lines facing each other.

16. An apparatus for organic layer deposition on a substrate, the apparatus comprising:
a carrier;
a deposition material source on a path of the carrier in a first direction;
a first sensor configured to measure an alignment error between a mask and a substrate, the mask being between the substrate and the deposition material source, and to output a first signal corresponding to the measured alignment error;
a second sensor configured to measure a shape of the substrate and to output a second signal corresponding to the measured shape of the substrate; and
a mask controller configured to control a position of the mask based on at least one of the first signal and the second signal,
wherein the alignment error is measured in a second direction and in a direction rotating around the second direction, the measured shape of the substrate comprises least one a flatness and a straightness of the substrate, the flatness of the substrate is measured in a third direction substantially perpendicular to the first and second directions.

17. The apparatus of claim 16, wherein the mask comprises a plurality of slits substantially perpendicular to the first direction.

18-20. (canceled)
